(19) United States
(12) Patent Application Publication
(10) Pub. No.: US 2024/0405906 A1
(43) Pub. Date: Dec. 5, 2024

(54) DYNAMIC PACKET RATE FOR IMPROVED TIMING AND PERFORMANCE

(71) Applicant: Net Insight AB, Solna (SE)

(72) Inventors: Magnus DANIELSSON, Stocksund (SE); Per LINDGREN, Strängnäs (SE)

(73) Assignee: Net Insight AB, Solna (SE)

(21) Appl. No.: 18/696,162

(22) PCT Filed: Sep. 29, 2022
(86) PCT No.: PCT/EP2022/077167

§ 371 Date: Mar. 27, 2024

(30) Foreign Application Priority Data
Oct. 1, 2021 (SE) 2151210-8

(51) Int. Cl. H04J 3/06; H04L 43/0864

(52) U.S. Cl. CPC H04J 3/0667; H04L 43/0864

(57) ABSTRACT

The present invention relates to methods, nodes and systems for enabling enhanced timing recovery between a first node and a second node in a network by adjusting the packet rate based on the link properties, the method including transmitting, from a first node to a second node, a plurality of packets using a first packet rate for transmission, monitoring, by the second node, one or more properties of the transmission of the plurality of packets to obtain a feedback parameter, transmitting from the second node to the first node, the feedback parameter based the on the one or more of the monitored properties, and selecting, in the first node, a second packet rate for transmission based on the received feedback parameter, wherein the feedback parameter transmitted to the first node i) allows the first node to select the second packet rate for transmission based on said parameter, or ii) is the second packet rate for transmission as determined by the second node based on the one or more properties of the transmission.

### TECHNICAL FIELD

The present invention relates to the field of signal transmission. More particularly, methods, nodes and systems for enhanced time transfer and timing recovery in a network is proposed, where using a dynamic packet rate for attaining more accurate and precise timing is proposed.

### BACKGROUND OF THE INVENTION

Time transfer in a network, such as for network synchronization (synchronization between nodes in a network), is essential for the function of a network. For example, many networks, such as packet based networks, require frequency and time synchronization (phase alignment) between nodes for successful operation and packet transfer, and many applications and services require the network to distribute accurate time and frequency to their nodes, such as mobile base stations, radio and TV transmitters, sensors, etc., operators may also provide synchronization services to their customers for use in their applications in for example servers or machines, or in self-driving cars.

The task of network synchronization is to distribute a reference signal from the primary reference clock (PRC) to all network elements requiring synchronization. The method used for propagating the reference signal in the network is usually the master-slave method, a.k.a. controller-responder, primary-replica, and leader-follower methods, a hierarchical model where the slave or responder clock must be slaved to (must respond to) a clock of higher (or equal) stability. Synchronization information is transmitted through the network via synchronization network connections. Synchronization network connections typically are unidirectional and generally point-to-multipoint. A centralized timing network architecture may be used, or a distributed timing network architecture (e.g. using Global Navigation Satellite System, GNSS).

Synchronization measurements may include phase measurements in view of reference signals, phase deviation and analysis of the phase time interval error, fractional frequency offset, maximum time interval error (MTIE) and time deviation (TDEV).

Time (relative and absolute) and frequency transfer describes mechanisms for comparing measurements of time and frequency from one location to another. Time transfer is a scheme where multiple sites share a precise reference time. Multiple techniques have been developed, often transferring reference clock synchronization from one point to another, often over long distances. Time transfer may be used for time synchronization between different entities or nodes in a network, which is essential for the function of the network. Packet based frequency distribution from a reference clock to a recovered clock comprises the steps generation from signal to packet, transfer including packet transmission over packet network, recovery from packet to signal.

A GNSS, or Global Navigation Satellite System, is a generic name for a group of artificial satellites that send position and timing data from their high orbits. The global positioning system, GPS, is just one of the many different sets of satellites that can provide such data. GPS (or GNSS) satellites include three or four atomic clocks that are monitored and controlled to be highly synchronized and traceable to national and international standards (known as UTC). So, for time synchronization, the GPS signal is received, processed by a local “master” clock, time server, or primary reference, and passed on (distributed) to “slaves” and other devices, systems, or networks so their local clocks are likewise synchronized to UTC. Thus, synchronization may be achieved using e.g. global positioning systems, e.g. by installing GPS receivers at transmitter sites. GPS receivers, however, may be easily intentionally or unintentionally jammed, or fail for other reasons such as equipment failure, and represent an additional cost in the network in terms of equipment and supervision. Further, the foreign control of the system may be an issue of concern, such as the military control of some GNSS systems, due to the dual use of government/military and civilian use.

Techniques for time synchronization of network nodes without utilization of GPS includes, for example, the network time protocol (NTP), which may be used to synchronize the clocks of network nodes to a master node or a reference clock using time stamps. The Precision Time Protocol (PTP) is a protocol used to synchronize clocks throughout a computer network, also known as IEEE 1588. IEEE 1588-2019 includes a profile concept, a.k.a. default profile or standard profile, defining PTP operating parameters and options. Several profiles have been defined for applications including telecommunications, electric power distribution and audiovisual. The earlier IEEE 1588-2008 introduced a clock associated with network equipment used to convey PTP messages. There are five basic types of PTP devices (“clocks”); ordinary clock (master or slave), boundary clock (“master and slave”), end-to-end transparent clock, peer-to-peer transparent clock and management node. All five types implement one or more aspects of the PTP protocol. The transparent clock modifies PTP messages as they pass through the device. Timestamps in the messages are corrected for time spent traversing the network equipment. This scheme improves distribution accuracy by compensating for delivery variability across the network. PTP messages may use the User Datagram Protocol over Internet Protocol (UDP/IP) for transport.

For packed-based transmissions, the impairment of the timing of received packets is due to the packet network that transports them. Since the network is realized based on an ideal situation, while actual dynamic variations when operating in the network may affect the outcome of the packet transfer, packet delay may be increased, and packet loss may occur. Upon experiencing poorer performance in view of delay or packet loss, such as synchronization packet loss, a backoff to a lower packet rate may be performed. However, this leads to a lower throughput in the network. Thus, improved methods for adjusting for delays and packet loss based on dynamic variations is needed.

### SUMMARY OF THE INVENTION

An object of the present disclosure is to provide methods and devices which seek to mitigate, alleviate, or eliminate the above-identified deficiencies in the art and disadvantages singly or in any combination.

This object is obtained by a method enabling enhanced timing recovery between a first node and a second node in a network, the method comprising transmitting, from a first node to a second node, a plurality of packets using a first packet rate for transmission, monitoring, by the second node, one or more properties, such as quality parameters, of the transmission of the plurality of packets to obtain a feedback parameter, wherein said properties may be selected from: min delay value variance between different blocks of packets, delay variance for all packets, dynamic change in value of a calculated internal node clock, packet loss, dynamic change in round trip time (RTT) of min packets, and quality parameters on all data packets on a link. The method further comprises transmitting, from the second node to the first node, the feedback parameter based the on the one or more of the monitored properties, and selecting, in the first node, a second packet rate for transmission based on the received feedback parameter, wherein the feedback parameter transmitted to the first node either i) allows the first node to select the second packet rate for transmission based on said parameter, or ii) is the second packet rate for transmission as determined by the second node based on the one or more properties of the transmission.

Thus, in some aspects, the first node receives a feedback parameter from the second node, wherein said parameter reflects the quality of the link on which the transmission is being performed.

In a certain embodiment, the property of the link being monitored in the variance of the min delays of the packets, between different blocks or within a same block. The feedback parameter comprises traffic load information, which, depending on which node that performs the steps of estimating the variance, may comprise different information. In some embodiments, only the timestamps t2 of the second node are transmitted to the first node and all calculations are made in the first node. In another embodiment, all calculations are made in the second node and the variance, or the steering parameter obtained from said variance, or even the determined new packet rate is sent to the first node from the second node.

According to some aspects, a method for use in a first node is proposed, for enabling enhanced timing recovery between the first node and a second node in a network, the method comprising transmitting a plurality of packets to a second node using a first packet rate for transmission, each packet comprising a timestamp t1, the timestamp t1 relating to a time when the packet was transmitted in relation to a local clock in the first node, receiving a feedback parameter comprising packet rate information from the second node, and selecting a second packet rate for transmission based on the received packet rate information, wherein the received packet rate information is based on one or more properties of the transmission of the plurality of packets, the one or more properties being selected from: min delay value variance between different blocks of packets, delay variance for all packets, dynamic change in value of a calculated internal node clock, packet loss, dynamic change in round trip time (RTT) of min packets, and quality parameters on all data packets on a link.

According to some aspects, a method for use in a second node is proposed, for enabling enhanced timing recovery between the first node and a second node in a network, the method comprising receiving, from a first node, a plurality of packets transmitted using a first packet rate for transmission, each packet comprising a timestamp t1, the timestamp t1 relating to a time when the packet was transmitted in relation to a local clock in the first node, timestamping each of the received plurality of packets with a timestamp t2, the timestamp t2 relating to a time when a respective packet was received in relation to a local clock in the second node, splitting the plurality of packets into a sequence of blocks of packets; transmitting a feedback parameter comprising packet rate information to the first node.

In some aspects, systems and nodes carrying out the above methods are provided.

Further objective of, features of, and advantages with, the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 illustrates time transfer over a packet network (100).

FIG. 2 is an illustration of a clock synchronization using PTP messages including an exchange of four timestamps between a reference clock and the clock to be synchronized.

FIG. 3 illustrates a theoretical background of the invention, where FIG. 3A depicts a histogram to illustrate the shape of the distribution of the time-differences between two nodes formed as a statistical distribution. FIG. 3B is a histogram illustrating the distribution of the packages after min-delay filtering or lucky packet filtering, illustrating how to make a selection of a delay of a packet in a block of packets. FIG. 3C depicts the distribution in FIG. 3B taking the approximate form of a right-angled square.

FIGS. 4A and 4B are block diagrams of a first and second node of the invention, respectively.

FIG. 5 shows a flowchart of an exemplary method for achieving enhanced timing recovery according to an embodiment of the invention.

FIG. 6 illustrates an embodiment of the invention where the packet rate may be based on the delay variance of min processed packets between different blocks or in a same block.

All the figures are schematic, not necessarily to scale, and generally only show parts which are necessary in order to elucidate the invention, wherein other parts may be omitted or merely suggested.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some embodiments a non-limiting term “node” or “network node” is used. It should be understood that this term refers to any type of node that may send and/or receive information, such as data and control information, over a network. A physical node is typically an electronic device that is attached to a network, and is capable of creating, receiving, or transmitting information over a communications channel. The node may be a data communication equipment (DCE) such as a modem, hub, bridge, router or switch, or data terminal equipment (DTE) such as a digital telephone handset, a printer, a server, or a host computer. In an example, the node may be a computer terminal connected to a network, such as a local area network (LAN), wide area network (WAN) or the Internet. In another example, a node may be synchronization equipment, such as a boundary clock or grandmaster connected to the network.

The term “network” refers to any type of network over which a network node may communicate, such as a local area network (LAN), wide area network (WAN) or the Internet. The network may use different network technologies such as Ethernet, SDH, SONET, PDH, ATM, DTM or IP. The network may be referred to as an Internet Protocol (IP) network, a communication network that uses IP to send and receive messages between one or more nodes or computers, which may be implemented in Internet networks, WAN, LAN and enterprise networks, for example. The service network may be used for mobile networks such as 2G/3G/4G/5G/6G networks, power networks, fntech network, or single frequency networks (SFN) or a media network including digital television (DTV) or a digital radio distribution network.

By “timing recovery”, “time recovery” or “clock recovery” is meant to recover a clock at the symbol rate or a multiple of the symbol rate from the modulated waveform. This clock is required to convert the continuous-time received signal into a discrete-time sequence of data symbols. In serial communication of digital data, clock recovery is the process of extracting timing information from a serial data stream to allow the receiving circuit to decode the transmitted symbols. Clock recovery from the data stream is expedited by modifying the transmitted data. Wherever a serial communication channel does not transmit the clock signal along with the data stream, the clock must be regenerated at the receiver, using the timing information from the data stream. Clock recovery is a common component of systems communicating over wires, optical fibers, or by radio.

The terms “IEEE 1588” and “Precision time protocol (PTP)” may be used interchangeably herein, and refers to a protocol used to synchronize clocks throughout a computer network.

The term “block” refers to a sequence of streamed packets being transmitted between two nodes. The term “block size” refers to a number of packets contained in a block, i.e. the length of the sequence of packets. The “block rate” refers to a rate for which different blocks are being transmitted, i.e. how often a block (stream of packets) is being transmitted from a transmitter to a receiver. The term “packet rate” refers to the rate for which packets are being transmitted between a transmitter and a receiver, and depends both on the block size (number of packets, or bytes, per block) and block rate (number of block per time unit). In some cases, if the blocks are sent back to back and the packet rate relates to the rate that the blocks are sent, then the block rate is the packet rate divided by the block size. A “block time”, refers to the length of time that a block is transmitted, and an “inter block time” refers to a time periodicity between the blocks, which controls the periodicity or frequency of the blocks. In some aspects, the block time and the inter block time is the same. A packet may also be referred to as a “sample”, as a packet results in a sample (time stamp pair consisting of transmitting time stamp and receiving time stamp) when being transmitted to a receiver.

Network traffic or data traffic is the amount of data moving across a network at a given point of time. Network data in computer networks is mostly encapsulated in network packets, which provide the load in the network. The term “traffic load” or “packet load” as used herein may be used interchangeably, and refers to the amount of traffic, such as packets, being transmitted in a network, or for a specific link, at a specific time instance or time duration.

Network delay is a design and performance characteristic of a telecommunications network. It specifies the latency for a bit of data to travel across the network from one communication endpoint to another. It is typically measured in multiples or fractions of a second. Delay may differ slightly, depending on the location of the specific pair of communicating endpoints.

In computer networking, packet delay variation (PDV) is the difference in end-to-end one-way delay between selected packets in a flow with any lost packets being ignored. The effect is sometimes referred to as packet jitter. PDV hence relates to the variation between the individual delays of different (selected) packets in e.g. a transmitted stream of packets, such as a block. As traffic load increases, so does the PDV of a transmitted block of packets. Also changes in configuration, reroutes, firmware upgrades and other events may affect the PDV.

The “min algorithm”, also referred to as “min processing”, min-delay filtering” or “lucky packet filtering” is a non-linear filtering method which, when being employed to the time stamp differences of a block of packets being transmitted from one node to another, by weighing the differences differently based on their value, allows for selecting a better value, which is whatever value of two that has lower delay. Thus, by the “delay” or “delay estimate” in this respect is referred to the time differences between the received time stamps and the transmit time stamps. In one example, the algorithm basically compares two delay values and selects the lowest of the two, then proceeds with the rest of the values.

Thus, in the filtering method the minimum delay packet is chosen to represent the best measure out of that block. The delay of the minimum delay packet is referred to as the “min delay”. The delay comprises the “background delay” of the network and the “traffic based delay”, where selecting the minimal delay is selected the one with the least traffic based delay.

Thus, “min processing”, as used herein, refers to a non-linear filtering method which, allows for selecting the better value of two compared values, which is whatever value of the two that has lower delay. By min processing all packets in a block, the best value, having the lowest delay, may be selected for each block, which value/corresponding packet is referred to as the “min sample” or “min delay”. Thus, by comparing all delays of all packets (samples) two-by-two and selecting the better value each time until all packets in a block has been processed, the sample with the lowest delay may be found. The order of processing the packets does not matter, it may be done sequentially or in any order an implementor may see fit, as any order will result in the better value being selected, as it will always be selected as the lowest delay sample out of two compared values. Thus, in the filtering method the minimum delay packet, the min sample, is chosen to represent the best measure out of that block. Thus, the min processing give rise to a number of min samples from a sequence of blocks, one min sample per block, which form a sequence of min samples.

The variance between these min samples/min delay values from different neighboring blocks may be estimated. By comparing said estimated variance to a preset nominal variance (preferred variance for a specific target application), a steering parameter may be obtained, which enables dynamically adjusting the packet rate to achieve the preferred variance, and thus preferred quality/tolerable quality impairment, which is linked to the network delay/impairment.

Accordingly, min processing selects a packet from each block having a lowest delay as a min sample of said block. Thus, comparing all values to select the lowest delay is performed by min processing on each of the blocks of packets. The min processing yields a distribution of min samples, referred to as a “min distribution”. Thus, min processing is performed to estimate, for each block of packets, a min distribution of the delays for each packet to obtain a sequence of min samples. By selecting the packet having the lowest delay as the min sample for said block, a sequence of min samples for all blocks can be obtained, which is a collection of min delays/samples for each block obtained from the min processing. The (statistical) distribution of said min samples is the “min distribution”. By estimating the variance between these min samples/min delay values, a min delay value variance, i.e. statistical variance, between different blocks of packets may be obtained.

Obtaining min samples by min processing can be achieved using either non-overlapping or overlapping blocks of samples, from an original set of measures. For non-overlapping blocks, there is no two block with common samples evaluating, whereas for overlapping blocks, later samples are used in subsequent block(s). The same min (sample) processing is performed for each block regardless of the processing is non-overlapping or overlapping. The overlapping block processing produce a higher rate of min samples than non-overlapping blocks. With a ¾ overlap of blocks, each sample can contribute in 4 blocks and the min sample series provide 4 times higher update rate than the non-overlapping processing.

In telecommunications, the Round Trip Delay (RTD) or Round Trip Time (RTT) is the length of time it takes for a signal to be sent plus the length of time it takes for an acknowledgement of that signal to be received. This time delay includes the propagation times for the paths between the two communication endpoints. In the context of computer networks, the signal is generally a data packet, and the RTT is also known as the ping time. An internet user can determine the RTT by using the ping command. End-to-end delay is the length of time it takes for a signal to travel in one direction and is often approximated by half the RTT.

Time (relative and absolute) and frequency transfer describes mechanisms for comparing measurements of time and frequency from one location to another. Frequency transfer may be performed using either physical layer options (SONET/SDH, SDSL, GPON, Synchronous Ethernet) or packet-based options (SATOP, CESoPSN, NTP, PTP). Using the packet-based option have several benefits, such as flexibility, simple in theory and applicable to both frequency and time, while the drawbacks are the complexity of the network and the network traffic, which make real life implementation not as easy as the ideal theoretical case. For example, the shifting traffic load greatly impact the outcome.

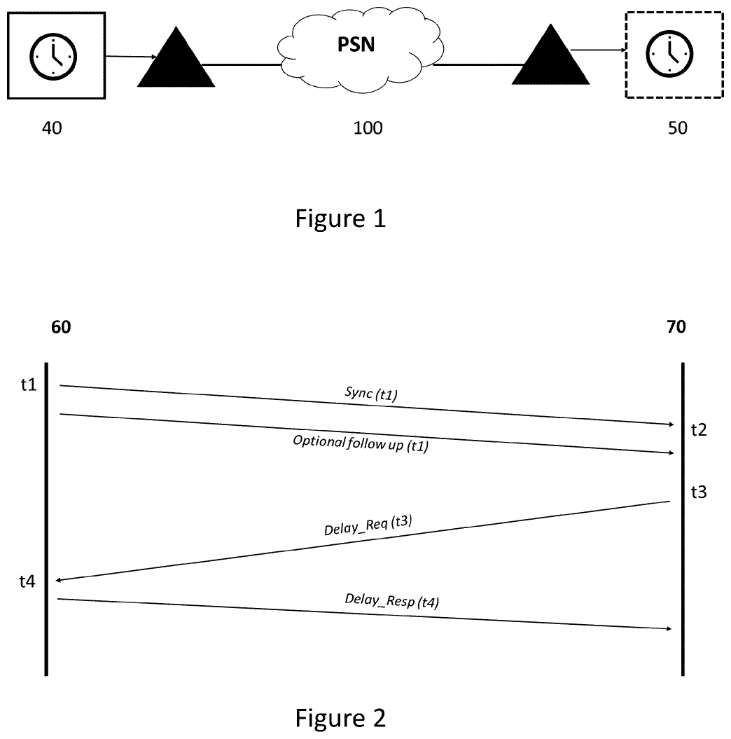

FIG. 1 illustrates time transfer over a packet switched network, PSN (100). A signal from a reference clock 40 is used for generation from signal to packet, transferred as a packet transmission over a packet network, 100, and recovered from packet to signal for recovery of the recovered clock, 50.

The ITU Telecommunication Standardization Sector (ITU-T) coordinates standards for telecommunications and Information Communication Technology. ITU-T The main products of ITU-T are Recommendations (ITU-T Recs)-standards defining how telecommunication networks operate and interwork. Study group 15 (SG15) Question 13 (Q13) have developed recommendations for packet based timing, such as Recommendation ITU-T G.781.1 which specifies a functional architecture model and corresponding atomic functions for the transport of time and frequency synchronization over packet-based networks, and Recommendation ITU-T G.8261/Y.1361, which defines frequency synchronization aspects in packet networks including the adaptive clock recovery definition: “In this case the timing recovery process is based on the (inter-) arrival time of the packets (e.g., timestamps or circuit emulation service (CES) packets). The information carried by the packets could be used to support this operation. Two-way or one-way protocols can be used.” It specifies the maximum network limits of jitter and wander that shall not be exceeded. It specifies the minimum equipment tolerance to jitter and wander that shall be provided at the boundary of these packet networks at TDM and synchronization interfaces. It also outlines the minimum requirements for the synchronization function of network elements. The requirements for the jitter and wander characteristics that are specified in the Recommendation must be adhered to in order to ensure interoperability of equipment produced by different manufacturers and a satisfactory network performance.

Time transfer is a scheme where multiple sites share a precise reference time. In a one-way time transfer system, one end transmits its current time over some communication channel to one or more receivers. The advantage of one-way systems is that they can be technically simple and serve many receivers, as the transmitter is unaware of the receivers. The principal drawback of the one-way time transfer system is that propagation delays of the communication channel remain uncompensated except in some advanced systems.

In a two-way time transfer system, the two peers will both transmit, and will also receive each other's messages, thus performing two one-way time transfers to determine the difference between the remote clock and the local clock. The sum of these time differences is the Round Trip Delay between the two nodes. It is often assumed that this delay is evenly distributed between the directions between the peers. Under this assumption, half the Round Trip Delay is the propagation delay to be compensated. A drawback is that the two-way propagation delay must be measured and used to calculate a delay correction. To calculate delays and determine compensation, information such as time stamps, time difference measurements, correction factors, and various statistics between nodes involved in two-way time transfer needs to be available. The two-way time transfer mechanism is the basis of all packet time transfer protocols, such as NTP and IEEE 1588 (PTP). They generally assume path symmetry and path consistency, although IEEE 1588 has the concept of asymmetry correction. However, the correction values are not dynamically measured-they need to be statically configured.

IEEE/PTP, a protocol that distributes frequency, phase and time over packet based network, has become the standard for distribution of high accuracy time. Following guidelines for specific network architectures allows the delivery of time to accuracies of one microsecond. This level of accuracy is required for mobile base stations using either Time Division Duplex technology and/or advanced LTE functions, as well as in the power industry for intelligent electronic device alignment. More lenient architectures can still achieve 100 microseconds or better accuracies which can greatly enhance the usefulness of event logging and network one way delay measurements. In addition, 1588 has been used to deliver a frequency reference for T1/E1 ports or for mobile base station frequency alignment. This is useful in environments where the transport network does not provide physical layer synchronization services.

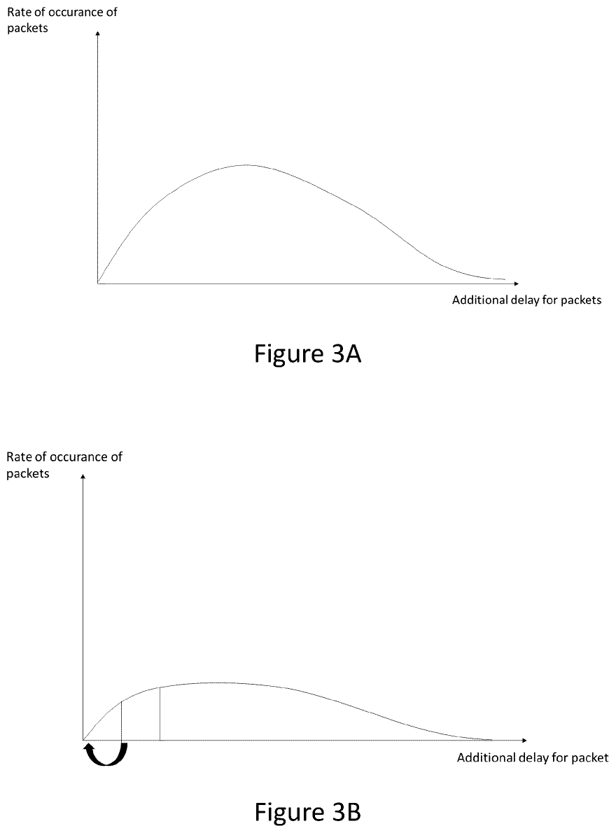

PTP uses an exchange of four timestamps between a reference clock (master port) and the clock to be synchronized (slave port), as illustrated in FIG. 2. The master (60) sends a PTP Sync message (Sync (t1)) containing a timestamp of when the Sync message is transmitted (t1) to the slave (70). In a two-step master clock, the t1 timestamp is sent in a Follow_Up message (Optional follow up (t1)). The slave records the time it receives the Sync message (t2). At some point after receiving the Sync message, the slave sends a Delay_Req message back to the master (Delay_req (t3)). The slave records the time of transmission of the Delay_Req message (t3) locally. The master records the time it receives the Delay_Req message (t4) and sends this timestamp back to the slave in a Delay_Resp message (Delay_Resp (t4)). After the four timestamp exchange the slave can calculate the mean path delay and the clock offset from master using the following two equations:

$$mean\_path \_delay = [ ( t 4 - t 1 ) - ( t 3 - t 2 ) ] / 2$$

$$offset\_from \_master = [ ( t 2 - t 1 ) - mean\_path \_delay ]$$

These calculations can occur on every message exchange or some initial packet selection can be performed so that only optimal message exchanges are used. The latter is useful if there is variable delay between the master and slave ports. If only frequency is necessary, then the slave may use one or both pairs of timestamps (t1, t2) and (t3, t4). The slave can monitor the change in the perceived delay master-to-slave (t2−t1) or slave-to-master (t4−t3) over time. If the delay (t2−t1) decreases over time, it means the t2 timestamps are not progressing quickly enough and the slave clock frequency needs to be increased. If time is necessary, then all four timestamps must be used. It is also important to note how the equation for offset uses the mean_path_delay. If the delays in the two directions are actually different, then the equation will introduce an error in the offset_from_master that is half of the difference of the two delays. The IEEE 1588 standard includes procedures to compensate for this asymmetry, if it is known, but if it is uncompensated it does introduce time error.

IEEE 1588 synchronization performance depends on several related factors. Among them, the symmetry of packet delay is the most basic one. But most existing networks could not provide symmetry packet delay between master and slave clocks. The First In First Out (FIFO) principle, which would make some packets transmitted delay, is called FIFO waiting. The uncertainty of FIFO waiting would lead packet delay variation (PDV). FIFO waiting during packet transmitting is one of the main reasons that lead the asymmetry. A packet delay estimation algorithm to select “lucky packets”, which survived from FIFO waiting, may improve the accuracy of packet delay estimation.

IEEE 1588 has provided effective solutions to realize high-accuracy synchronization based on network. Following the “delay require-response” principle, the protocol transfers packets periodically to provide precision timestamps for estimating the offset from master-to-slave in IEEE 1588 slave clocks. According to the estimated offset, slave clocks would adjust its local clock through servo system. After several periodical adjustment, slave clocks could achieve synchronization with master clock in the end. The process of IEEE 1588 synchronization could be divided into two steps: clock offset measurement and packet transmission delay measurement. In the process of clock offset measurement, master clock would send synchronization packet “Sync” to slave clock and meanwhile mark the precision leaving time of packet “Sync” as T_{Sync_Tx}. And then, slave clock would mark the precision arriving time of packet “Sync” as T_{Sync_Rx}. Since the leaving time information T_{Sync_Tx} could not be included into the packet “Sync” precisely, IEEE 1588 defines packet “Follow_up” to transmit the leaving time information of packet “Sync” precisely. If we define the packet transmission delay from master to slave as MS_{delay}, and the offset between master and slave as Offset, we can calculate the offset as

Offset=T_{Synch_Rx}−T_{Synch_Tx}−MS_{delay}

The unknown MS_{delay} could be calculated by packet transmission delay measurement. In the process of packet transmission delay measurement, slave clock would firstly send delay requirement packet “Delay_req” to master clock and meanwhile mark its precision leaving time as TDelay_Req_Tx. And then, master clock would mark the precision arriving time of packet “Delay_req” as TDelay_Req_Rx. In the end, master clock would send the arriving time information back to slave clock with packet “Delay_resp”. If we define the packet transmission delay from slave to master as SM_{delay}, then

SM_{delay}=T_{Delay_req_Rx}−T_{Delay_req_Tx}+Offset

Here, IEEE 1588 has a basic assumption that the packet transmission delay from master to slave is the same as from slave to master, that is to say

MS_{Delay}=SM_{Delay}

Based on this assumption, we can get the offset

$$Offset = ( ( {T}_{Synch \_ Rx} - {T}_{Synch \_ Tx} ) - ( {T}_{Delay \_ req \_ Rx} - {T}_{Delay \_ req \_ Tx} ) ) / 2$$

Thus, we can get that the accuracy of estimated offset is nearly related to the symmetry of packet delay. If the assumption that packet delay is symmetry could be met, the estimated offset would reflect the real offset. But if the assumption could not be meet, the synchronization based on estimated offset would be damaged.

The 1588 standard (1588v2) includes the concept of a PTP profile. A PTP profile allows standardization bodies or industry groups to adapt the 1588 standard to a particular application. A profile defines which aspects of the 1588 standard are included or excluded, along with configurable ranges and defaults necessary for the application. The 1588 standard itself includes a default profile that can be used for either time or frequency distribution. The default profile was defined principally for multicast operation. However, it can be used with the unicast sessions as well. The default profile supports all 1588 clock types and includes the Best Master Clock Algorithm (BMCA) that automatically builds the synchronization distribution hierarchy amongst the PTP clocks. The packet rates are typically statically defined for a certain profile, hence adapting the packet rate dynamically may not be possible using the PTP profiles of the prior art, hence defining new profiles may be needed, which new profiles support dynamic rate.

Time-based communications is a technology where an active data communications channel is used as a vehicle for two-way time transfer. Precision timing is provided in the background of an active data transfer channel (one that is being used for data communication). This allows two ends of a communications link to be precisely synchronized without fielding an independent timing system. For packed-based transmissions, the impairment of the timing of received packets is mainly due to the packet network that transports them. Upon experiencing poorer performance in view of delay or packet loss, such as timing/synchronization packet loss, a backoff to a lower packet rate may be performed. However, this leads to a lower throughput in the network.

In view of the above identified problem, the object of the present invention is to provide a method allowing for dynamic packet rate transmission. The current disclosure thus provides solutions to the above-mentioned problems and drawbacks of impaired performance of a packet based network due to heavy traffic, where synchronization/timing packets may be delayed or lost. By dynamically increasing the number of synchronization packets based on the traffic load, the drawbacks of the prior art may be mitigated.

An aim of the present disclosure is to optimize time distribution by using two-way time transfer protocols, such as PTP IEEE1588, over networks with dynamic traffic, i.e. over computer switches and routers with buffering through the nodes which results in different delays. The reason behind altering the packet rate (number of packets sent per time unit) is that most two-way time transfer systems use so-called “lucky packets” to calculate the delay between two nodes when you have a network with different amount of traffic. The assumption is that if you only count on the best packets (e.g. a 0.1% percentile), you hope that they have passed through the network without or with very little buffering and you then only get the static delays in the links (optical delay) and in the nodes (static processing delay), but avoids the dynamic delays created in queues in buffers. If you get an exact delay, you can use the so-called Two-Way Time Transfer protocol to distribute time between nodes and compensate node by node for delay between each hop. If you send too few sync packets, you get too poor probability that you get through enough packets with low buffering, i.e. you get too high variance between the packets in the receiving node and get poor accuracy when trying to calculate the delay (and thus correct time). If you send too many packets on the other hand, it creates overhead and unnecessary traffic in the networks, so you want to measure and send optimally many sync packets.

Thus, to mitigate this you need to be able to change the number of packets (packet rate) with time information you send in the transmitter node depending on feedback from the receiver node or depending on the type of link between the sync nodes. In the receiver node, you need to monitor either Quality in receiving data (all data packets), in receiving sync packets (only sync data packets) or based on calculated delay or RTT, and any change (derivatives) of these. Quality could be many parameters, such as packet loss and variance in delay (jitter or PDV) of these packets. Feedback is sent to the transmitter node (first node). The decision (intelligence) to change can be made in the transmitter or receiver nodes.

The theoretical base of the current invention is based on the realization that for a packet-based transmission, for which phase, frequency or time is estimated either using one-way or two-way mechanisms, the impairment of the timing of received packets is due to the packet network that transports them. This network has intrinsic variations due to its realization given no traffic load, and in addition provides a significant timing impairment due to traffic load, impacting the timing of packets both directly and indirectly. An example of direct impairment is adding other packets into packet-buffer, providing a head-of-line blocking causing additional delay for the timing packets. An example of indirect impairment is that traffic affects the scheduling of transmission of packets is affected by processing of other packets. Implementation forms of schedulers, together with traffic and configuration, creates a range of behaviours, all leading to other traffic affecting the actual delay of timing packets.

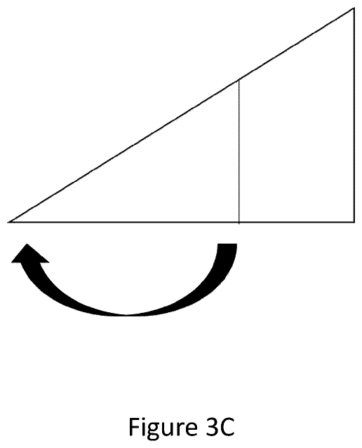

A simple model to understand these impairments is to consider a transmitter node A generating a stream of packets, each having a time-stamp of the transmission time in some clock of the transmitter node. As these packets is received in a receiver node B, each packet is time-stamped of the reception time, in some clock of the receiver node. As one looks on the difference of these time-stamps for the same packet, one get an estimation of the elapsed time from the transmitter to the receiver node. This estimation will be biased by the time-difference of the two nodes, but for the general discussion we will assumed that this time-difference is zero or static. Further, the basic delay of the empty network will cause a basic delay. Given a large set of such time-differences, one can analyze them statistically by means of creating a histogram to illustrate the distribution, see FIG. 3A. FIG. 3A depicts a histogram to illustrate the distribution of the time-differences between two nodes formed as a statistical distribution of rate of occurrent for packets (y-axis) for a particular additional delay (x-axis). This distribution can have many different forms, but tends to have a low mean value, while having a long “tail” of low probability for long delays, similar to the curve given. Thus the curve serve to illustrate one such distribution out of many possible. For the purpose of the invention, the increasing rate of occurrence from the minimum delay is the critical property, as the aim of the minimum processing is to ignore the details of the shape of the remaining curve by just ignoring samples, and thus distribution shape, of those having a larger delay as choosing those having the minimum delay over the block of processing. Thus, by creating a set of bins for a range of values, one count the occurrence of difference samples to be within such a range. The produced histogram will form a statistical distribution. This will have the first occurrence near the minimum delay of the medium.

For classical processing, one use all these time-stamps differences to steer a recovered clock. This provides an estimated time which will be the mean value of the distribution, all assuming same weight to all values. While simple, this have a draw-back since the variations provided by the network creates a huge variation. At the same time, the distribution is not symmetric around mean, as assumed from normal gaussian distribution, it is asymmetric. As variation grows, it does so by having more and more packets experience more delay, thus being further away from the minimum delay. This also shifts the mean value of the packets. As traffic load changes, the distribution changes and thus the mean value changes.

In order to address this, non-linear filtering methods have been employed. Considering that the distribution still has some packets being near the minimum delay, those have higher value for timing than those further away. Thus, by weighing differences differently based on their value, a better value can be chosen, and this is whichever value of two that has lower delay. A number of such packets can be evaluated over a range, and the minimum delay packet is chosen to represent the best measure out of that block. This is from the packet that was lucky enough to go through the network with least impairment, from the given set of packets. This have led to the names of min-delay filtering or lucky packet filtering. It has been shown that such filtering can have significant reduction of variation compared to the unfiltered set of samples.

The result will be a larger set of packets and their distribution will be replaced by a smaller set of packets, sharing the left-hand shape of the larger distribution, as illustrated in FIG. 3B. FIG. 3B is a histogram illustrating the distribution of the packages after min-delay filtering or lucky packet filtering, as illustrated by the lines. In FIG. 3A the shape of the curve is illustrated, while the distribution in 3B illustrates, for one block of packets with the shape in 3A, how to do a selection of the delay of said packets to get a lower value more to the left on the curve. This new distribution depends on the larger distribution depicted in FIG. 3A, but have its own distribution properties, including mean value. As the traffic load change the shape of the large distribution, it will inadvertedly also change the shape of the smaller, and thus the mean value. The more packets that are used in the min-processing, the more packets have a probability of belonging to the left part of the curve, and hence be able to be used as the minimum value of said block. Assuming that the min-processing is done over sufficiently many packets, and their associated time-stamp differences, the smaller distribution will be essentially a rising slope as part of the left-most rising slope of the larger distribution. The vertical lines are introduced in the graph to symbolize this. One is to exemplify if we use e.g. 100 packets for min-processing (the vertical line to the right), and the other if we use e.g. 200 packets (vertical line to the left). Hence, an ability and method to suppress the properties of varying block sizes is attained.

One can approximate the distribution to take the form of a right-angled square as illustrated in FIG. 3C, which base has the length being the minimum and maximum of this range of this longer sequence. It is emphasized that the triangle approximation is an idealized distribution, that an actual right square triangle is not really formed.

It is illustrated how the traffic variations alter the “standard” delay from the position of the arrow, depending on the traffic load, to the vertical lines, where a smaller block size is illustrated as the vertical line to the right, while a larger block size is shown as the left vertical line. Thus, for a larger block size one will increase the probability of achieving a sample (packet) with a lower delay, and hence a decreased spread of min-values between different blocks. Thus, the variations are decreased by using a larger block size, hence identifying the possibility of altering the packet rate or block size depending on the attained variation, since it affects the impact attained from the network. From geometry, we can estimate the mean value based either on the mean of the samples, or from the detected min and max values of the sequence, and then the mean is ⅔ of the length.

An object of the present disclosure is make use of the way that the characteristics change in the sequence of samples produced from a set of raw measurement samples, as measured on the network connection from a transmitting node to a receiving node in FIG. 1 with the aim to recover with best fidelity the timing of the transmitting node while suppressing the delay variations inflicted by the network upon transmitting a set of packets over said network. The packets holding time-stamp of transmission from the transmitting node and attaining receive time-stamp of the receiving node allow for the estimate of the delay between the nodes, by taking the difference of these time-stamps, as biased by the offset of the clocks. The aim of this invention is to suppress the variations, at which time the bias between the nodes can be ignored if it remains near constant over the time for which a block of samples is processed, and a short sequence of contiguous such estimates. Therefore one can compare the samples and choose that of minimum estimated delay, as this will represent the sample in that set of samples having least bias from the delay the path would have if no buffer delays would be added by the interconnecting network equipment. Considering the fact that the samples and the frequency of occurrence of packets with a particular additional delay, as illustrated in FIG. 3A, the number of samples, typically contiguous, will when increased in number also increase the similarity of the distribution for this set, to that of the distribution measured over a large set. This results in higher probability of having packets covering the low-delay end of the distribution, which is also having least impact of the network variations we aim to reduce.

Thus, this invention aim to dynamically adjust the number of samples used (packets) to perform the minimum processing in order to increase ability to suppress noise as needed. The control can be steered by monitoring the statistical properties either of the incoming set of samples, or that of the produced set of minimum samples. The basic approach is to let the control increase the length of the block of samples over which minimum processing is performed over. This however would for a fixed rate of packets and thus fixed rate of delay estimates decrease the rate of produced minimum estimates for back-to-back processing or for overlapping processing maintain a higher processing delay, both can be critical processing parameters and impairment in their own right, at which time a further improvement would be to let the receiving node steer the rate of the transmitting node to increase the rate of packets, such that more measurements is done per time-unit while increasing the number of samples processed in the receiving end to produce a more uniform processing rate. Similarly at times where produced statistics is lower than needed, the block length may be reduced, and transmitted packet rate may be reduced. The benefit being that the transmission will automatically tune itself with reduced need for manual intervention. In one embodiment of this invention, where packet rate may not be controlled, either because rate fixed from a transmitter which cannot be controlled or variation thereof would cause severe effects, the receiver would only adjust its block length dynamically as suitable, at which time it needs to adapt to the different characteristics as rate and delay properties of produced samples vary.

Packet delay variations (PDV) increase the risk of packet loss and hence poorer quality of the transferred information, such as poorer video quality when streaming video. In order to combat packet delay variations, it is important to have a lot of measures into the min-algorithm (lucky packet filtering).

As the traffic load changes, the overall distribution changes and with that the min distribution, the mean value of the min distribution changes. One way to reduce this variation is to increase the size of the block of difference samples, and thereby “clip” the overall distribution further to the left. A factor of two increase of block length will remove half the samples creating the lower distribution seen in FIG. 3B, and this will be the top ⅓ half of samples, above the mean value of the min-distribution for the smaller block-length.

The current invention lies in the realization that changing the block size dynamically can improve the produced quality. Typically, one wants a minimum update rate due to clock stability, so that would require the block rate to be maintained while block size increase, at which time the dynamical change of the block rate can be employed.

The mean of delays of packets in a transmission of a stream of packets between a first and a second node may be used for clock recovery. As traffic load changes, variation grows as the number of packets experiencing more delay increases, hence shifting the mean value, giving a less accurate timing recovery of the recovered clock. To address this, non-linear filtering may be used (e.g. min-filtering), reducing the variation. However, as the traffic load increases, so does the variation also for the min distributed packets and the mean value of the min distribution. This may be addressed by increasing the size of the block of difference samples. Typically, one wants a minimum update rate due to clock stability, so that would require the block rate to be maintained while block size increase. Thus, changing the block size dynamically can improve the produced quality.

Thus, in essence, when performing time transfer and time recovery, such as for synchronizing a second node to a first node, (synchronization) packets may be sent. However, increased traffic load may increase the delay variation of the packets, giving rise to a poorer performance and synchronization, leading to deteriorated link quality, as increased PDV (jitter) also increases the risk of packet loss. By altering the number of synchronization packets dynamically depending on the traffic load, an improved timing and link quality may be assured.

Thus, the aim of the present invention is to minimize gitter and achieve a target stability to ensure a good enough performance when transmitting packets in a network or system, without overloading the network. To achieve this, a number of link properties or quality parameters may be monitored by a receiving node, such as min delay value variance between different blocks of packets, wherein the min delay for a block comprises a delay of the minimum delay packet of the block obtained by min processing, delay variance for all packets (may be in a same block), dynamic change in value of a calculated internal node clock, packet loss, dynamic change in round trip time (RTT) of min packets, and quality parameters on all data packets on a link. In one embodiment, the variance, such as the min delay value variance between different blocks of packets, or delay variance for all packets in a same block, is monitored and used to attain a steering parameter for adjusting the packet rate.

In one embodiment, the min delay of a distribution curve for a plurality of transmitted packets is adjusted based on the amount of delay, to achieve a better timing recovery between a first and second node in a network. By increasing the packet rate, more packets may be received in a block of packets, and hence the probability of a lower min delay is attained. Thus, instead of keeping a fixed packet rate of a number of packets per second and a fixed block size, a dynamic variation is allowed, which is steered by the statistic probabilities of achieving a certain preferred min delay. The packet rate (number of samples per second) may be adjusted, which may attain a different number of samples per block, i.e. a different block size. In one embodiment, the packet rate and the block size are not necessarily linked, but may be varied. The packet rate and block size may thus be regulated dynamically. The attained method is thus an automatic self-regulated dynamic process for achieving a target stability in a system or network, without the need for manual intervention. The aim is to use the packet rate needed, no more no less.

To keep a desired performance in a system/network we set a target, a nominal requirement of the preferred variance, that we wish the system to maintain, referred to as a “nominal variance value”. This nominal requirement (setpoint) may be set differently based on the target application. With “application” in the context of “target application” is referred to the application being realized by transferring information over the network, and may also be referred to as “network application”, such as 5G mobile station, power grid phasor measurement unit (PMU), digital terrestrial transmitters, and other similar critical infrastructure requiring coordinated common time. Network applications may include computer applications that participate in a computer network. These applications talk to each other by plugging into the network. Different applications may have different stability and time demands, thus the preset nominal variance value will differ between applications to meet overall system goals. The “target application” is thus the application aimed at being performed using the network, i.e. the target, in view of which the nominal variance value is set. The value may be set based on previous knowledge, or predetermined based on ideal conditions. To keep the desired performance (preferred variance) when the conditions in the network change, such as increased or decreased traffic load in the system/network, the packet rate is adjusted.

To determine the amount of gitter or disturbance in the network at a certain time, the variance between the packets are measured. To adjust the packet rate based on the disturbance in the system (network) to conform to the nominal requirement for performance, the variance of the time delay for the plurality of packets (block of packets) is measured, min processed and compared to the nominal requirement to attain a steering parameter, after which the packet rate is adjusted so that the steering parameter, the difference between the min processed variance (steering parameter) and the nominal requirement (nominal variance value), is 0.

In one aspect of the invention, a first node sends a plurality of packets to a second node. The second splits the plurality of packets into a sequence of blocks of packets. The packets are timestamped in the first node with a timestamp t1 when transmitted, and timestamped in the second node with a timestamp t2. In one embodiment, the difference of the timestamps t1 and t2 is calculated in the second node. In another embodiment, the timestamp information T2 is transmitted to the first node, and the difference is calculated in the first node. In one embodiment, the second node calculates the variance of the packets in a block of packets. In another embodiment, the variance is calculated in the first node. In one embodiment the second node compares the calculated variance to the nominal requirement or setpoint for the desired variance to attain a steering parameter, which may go into the integrating part of distribution. If this steering parameter is positive, then the packet rate needs to be increased to conform to the nominal requirement/setpoint. If the steering parameter is negative, then the packet rate needs to be decreased to conform to the nominal requirement/setpoint. The goal is that the steering parameter approaches zero. Then the desired performance is achieved with the minimum packet rate needed. In another embodiment, the first node perform the comparison. In one embodiment, the second node determined the desired packet rate for conforming to the nominal requirement/setpoint based on the steering parameter. The second node then sends the desired packet rate to the first node. In another embodiment, the steering parameter is obtained at the first node (received or determined), and the desired packet rate for conforming to the nominal requirement/setpoint based on the steering parameter is determined in the first node. The first node then adjust its current packet rate to the received or determined desired packet rate. In some embodiments, the packet rate may have a min and max value which it may attain, and reaching the maximal packet rate may set off an alarm, i.e. triggering the attention of the used/operator, such as the link/application used appearing on an alarm list at the operator or at a centralized network management location.

Since there are limitations to number of packets per block, such as in PTP profiles, the dynamic properties used today merely relates to performing a backoff to a lower rate. However, in the setting of the present disclosure, a flexible number of packets (block size) may be used. Increasing the number of packets increases the probability of a delay estimate of low jitter variance and mean thus resulting in better precision and accuracy using the min algorithm. The alteration of the packet rate is based on the quality of the link, where a quality parameter may be monitored. Altering the packet rate decreases the overhead for the synchronization packets as no manual intervention is needed.

The exact mechanism to control the packet rate change can differ in different implementations, it may encompass to increase or decrease one's own packet rate to a server echo-ing back in that rate, or it could be signaling to the transmitter to change its rate to the receiver. The later setup would allow asymmetric packet rates depending on the situation.

Thus, the concept of the invention is to dynamically alter the block packet rate for improved timing. Such a dynamic packet rate may be steered by monitoring the properties observed, and adjust to maintain an acceptable service, according to some configuration for that link. Maximum and minimum rate may be set. When the maximum rate has been reached and performance would request for even more packets, a specific alarm may be set.

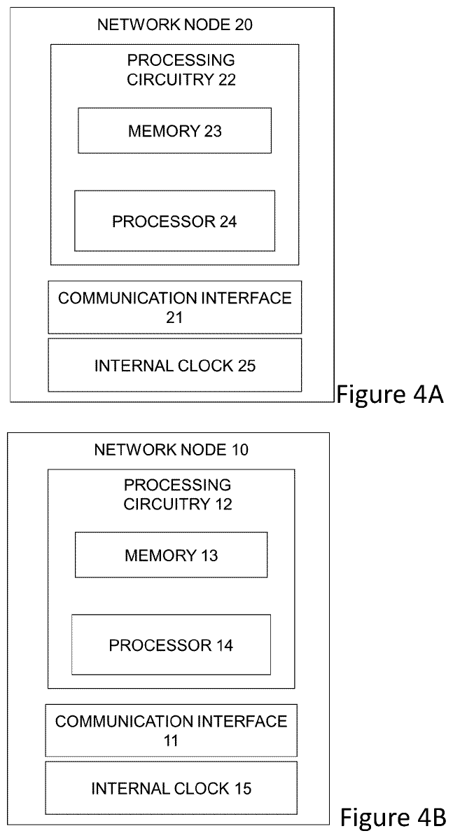

FIG. 4A illustrates a block diagram of a network node (20) of the invention. The network node comprises a communications interface 21 (e.g. a radio communication interface or radio circuitry or network interface) 21, configured to receive and transmit any form of communications or control signals within a network, e.g. for connecting the node to at least one neighboring node, such as a master or slave node, and for sending and receiving data over transport links. It should be appreciated that the communication interface (radio circuitry) 21 is according to some aspects comprised as any number of transceiving, receiving, and/or transmitting units or circuitry. It should further be appreciated that the radio circuitry 21 can e.g. be in the form of any input/output communications port known in the art. The radio circuitry 21 may comprise RF circuitry and baseband processing circuitry (not shown).

The node further comprises processing circuitry 22 comprising a memory 23 and a processor 24 being configured to carry out the method of the invention. The node 20 according to some aspects further comprises at least one memory unit or circuitry 23 that is in communication with the radio circuitry 21. The memory 23 can e.g. be configured to store received or transmitted data and/or executable program instructions. The memory 23 is e.g. configured to store any form of contextual data. The memory 23 can e.g. be any suitable type of computer readable memory and can e.g. be of volatile and/or non-volatile type. The memory may for example log received time stamps. The network node 20 further comprises processing circuitry 22 which configured to cause the network node 20 to carry out the methods of the invention.

The processing circuitry 22 is e.g. any suitable type of computation unit, e.g. a microprocessor, Digital Signal Processor, DSP, Field Programmable Gate Array, FPGA, or Application Specific Integrated Circuit, ASIC, or any other form of circuitry. It should be appreciated that the processing circuitry need not be provided as a single unit but is according to some aspects provided as any number of units or circuitry. The processing circuitry may thus comprise both a memory 23 for storing a computer program and a processor 24, the processor being configured to carry out the method of the computer program.

The controller, CTL, or processing circuitry 22 is according to some aspects capable of executing computer program code. The computer program is e.g. stored in a memory, MEM, 23. The memory 23 can be any combination of a Read And write Memory, RAM, and a Read Only Memory, ROM. The memory 23 in some situations also comprise persistent storage, which, for example, can be any single one or combination of magnetic memory, optical memory, or solid state memory or even remotely mounted memory. It should be appreciated that the processing circuitry need not be provided as a single unit but is according to some aspects provided as any number of units or circuitry.

According to some aspects, the disclosure relates to a computer program comprising computer program code which, when executed, causes a network node to execute the methods described above and below.

The node may comprise an internal clock, and may be able to provide and store timestamps in relation to said internal clock, and store time stamps in relation to other nodes. The node may also comprise a GPS/GNSS receiver if being a master node.

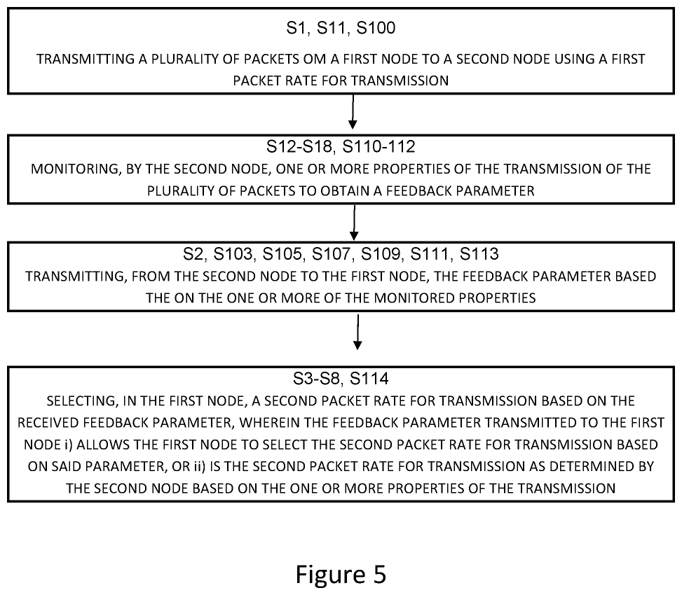

As illustrated in the flow chart of FIG. 5, in one aspect, a method for enabling enhanced timing recovery between a first node and a second node in a network, comprises transmitting (S1, S11, S100), from a first node to a second node, a plurality of packets using a first packet rate for transmission, monitoring (S12-S18, S110-112), by the second node, one or more properties of the transmission of the plurality of packets to obtain a feedback parameter, transmitting (S2, S103, S105, S107, S109, S111, S113) from the second node to the first node, the feedback parameter based the on the one or more of the monitored properties, and selecting (S3-S8, S114), in the first node, a second packet rate for transmission based on the received feedback parameter, wherein the feedback parameter transmitted to the first node i) allows the first node to select the second packet rate for transmission based on said parameter, or ii) is the second packet rate for transmission as determined by the second node based on the one or more properties of the transmission. The one or more properties being monitored is selected from: min delay value variance between different blocks of packets, delay variance for all packets, dynamic change in value of a calculated internal node clock, packet loss, dynamic change in round trip time (RTT) of min packets, and quality parameters on all data packets on a link. Thus, the second node may monitor properties related to min delay variance of the min packets (where different alternatives to calculate min delay variance may be used), the delay variance of all synchronization packets, the dynamic change (increase in derivate) in value of calculated node clock, the packet losses of transmissions on the link, and/or quality parameters on all data packets on link, instead of just monitoring sync packets. These properties may also be referred to as quality parameters. The first (sending) node may make determinations of quality parameters by e.g. receiving a set of associated time stamps from received sync packets (or results from calculations thereof as described herein), o RTT (calculated at sending node) or info on type of link used. e.g., different packet rates over dark fiber or a radio link, Internet or an IP/MPLS network etc.

In some embodiments, the feedback parameter comprises packet rate information, which may be used for selecting a new, second, packet rate for transmission. In a detailed example, the variance of the min delay values between two or more blocks is estimated, the min delay value being the smallest delay for a packet in said block obtained by min processing on each of the blocks of packets, where the variance is used for attaining a steering parameter by comparing the variance with a preset nominal variance value. The steering parameter should approach zero so that the actual variance approaches the preset nominal value, which may be achieved by altering the packet rate.

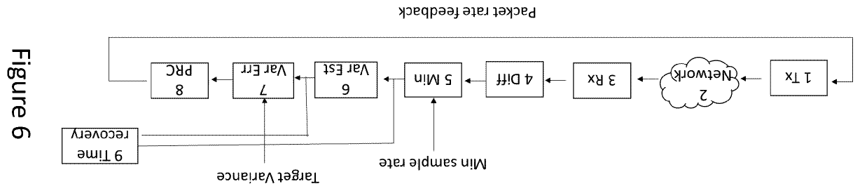

FIG. 6 shows a system overview of an exemplary embodiment, where the different steps are represented by boxes. In box 1 the transmission from a transmitting node (first node) includes the transmitting Tx timestamps, t1, for the plurality of packets being transmitted using a first packet rate for transmission. The packets are transmitted over the Network, 2, generating a dynamic delay. In box 3 the receiving node timestamps the received packages with receiving timestamps Rx, t2. In box 4 the differences between the timestamps t2 and t1 are being calculated, Diff. The obtained differences are min processed in box 5, to obtain a min delay value for each block, Min. In box 6 the min values are used for variance estimation, such as estimating the variance of the min delay values between two or more neighboring blocks, to obtain the Var Est. In box 7, the estimated variance Var Est is compared with a preset, predetermined or precalculated nominal variance value (target variance) to obtain a variance difference or error between the actual variance and the ideal variance, Var Err, which may be used as a steering parameter for adjusting the packet rate. In box 8, packet rate control, PRC are performed, where the packet rate is adjusted based on the steering parameter (Var Err) so that the parameter approaches zero, wherein if the steering parameter is positive, the packet rate is increased, and if negative, the packet rate is decreased, and if zero, the packet rate is maintained, the new packet rate being fed back to the transmitting node unless determined therein.

It should be emphasized that the actions in boxes 4-8 may be performed in either one of the sending or receiving node (first and the second node), as different implementations of the method. In box 5 the min sample rate is used in the min processing, and time recovery, box 9, may be performed either based on the obtained min delay value from box 5, or the estimated variance from box 6. By adjusting the packet rate for transmission based on the dynamic needs, the timing recovery will be enhanced.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

### Itemized Embodiments

1. A method for enabling enhanced timing recovery between a first node and a second node in a network, the method comprising:
   transmitting (S1, S11, S100), from a first node to a second node, a plurality of packets using a first packet rate for transmission;
   monitoring (S12-S18, S110-112), by the second node, one or more properties of the transmission of the plurality of packets to obtain a feedback parameter;
   transmitting (S2, S103, S105, S107, S109, S111, S113) from the second node to the first node, the feedback parameter based the on the one or more of the monitored properties; and
      selecting (S3-S8, S114), in the first node, a second packet rate for transmission based on the received feedback parameter, wherein the feedback parameter transmitted to the first node i) allows the first node to select the second packet rate for transmission based on said parameter, or ii) is the second packet rate for transmission as determined by the second node based on the one or more properties of the transmission.
2. The method according to item 1, wherein the one or more properties being monitored is selected from: min delay value variance between different blocks of packets, delay variance for all packets, dynamic change in value of a calculated internal node clock, packet loss, dynamic change in round trip time (RTT) of min packets, and quality parameters on all data packets on a link.
3. A method for use in a first node, for enabling enhanced timing recovery between the first node and a second node in a network, the method comprising:
   transmitting (S1) a plurality of packets to a second node using a first packet rate for transmission, each packet comprising a timestamp t1, the timestamp t1 relating to a time when the packet was transmitted in relation to a local clock in the first node;
   receiving (S2) a feedback parameter comprising packet rate information from the second node;
   selecting (S8) a second packet rate for transmission based on the received packet rate information, wherein the received packet rate information is based on one or more properties of the transmission of the plurality of packets, the one or more properties being selected from: min delay value variance between different blocks of packets, delay variance for all packets, dynamic change in value of a calculated internal node clock, packet loss, dynamic change in round trip time (RTT) of min packets, and quality parameters on all data packets on a link.
4. The method according to item 3, wherein the second node has split the plurality of packets into a sequence of blocks of packets and, for each of the plurality of packets, timestamped it with a timestamp t2, the timestamp t2 relating to a time when a respective packet was received in relation to a local clock in the second node, the method further comprises:
   determining (S3) time differences between the timestamps t2 and t1 for each packet in each block of packets to obtain a delay for each packet;
   performing (S4) min processing on each of the blocks of packets to obtain a min delay value for each block, the min delay value being the smallest delay for a packet in said block;
   estimating (S5) the variance of the min delay values between two or more blocks, such as adjacent/neighboring blocks;
   comparing (S6) the estimated variance with a preset nominal variance value to obtain a steering parameter;
on condition that the obtained steering parameter is positive:
   increasing (S7A) the packet rate such that the steering parameter becomes zero to obtain a second packet rate;
   on condition that the obtained steering parameter is negative:
   decreasing (S7B) the packet rate such that the steering parameter becomes zero to obtain a second packet rate;
on a condition that the obtained steering parameter is zero,
   maintaining (S7C) the first packet rate to obtain a second packet rate; and
   selecting (S8) the second packet rate for transmission based on the received packet rate information as the obtained second packet rate;
   wherein the steps S3-S7 may be performed by any of the first node and the second node.
5. The method of item 4, further comprising:
   on condition that the received packet rate information comprise information relating to how the second node has split the plurality of packets into a sequence of blocks of packets and, for each of the plurality of packets, a timestamp t2, the timestamp t2 relating to a time when a respective packet was received in relation to a local clock in the second node,
      determining (S3) time differences between the timestamps t2 and t1 for each packet in each block of packets to obtain a delay for each packet;
      performing (S4) min processing on each of the blocks of packets to obtain a min delay value for each block, the min delay value being the smallest delay for a packet in said block;
      estimating (S5) the variance of the min delay values between two or more blocks, such as adjacent/neighboring blocks, or the variance of the min values within a same block;
      comparing (S6) the estimated variance with a preset nominal variance value to obtain a steering parameter;
      on condition that the obtained steering parameter is positive:
         increasing (S7A) the packet rate such that the steering parameter becomes zero to obtain a second packet rate;
         on condition that the obtained steering parameter is negative:
         decreasing (S7B) the packet rate such that the steering parameter becomes zero to obtain a second packet rate;
      on a condition that the obtained steering parameter is zero,
         maintaining (S7C) the first packet rate to obtain a second packet rate; and
      selecting (S8) a second packet rate for transmission based on the received packet rate information as the obtained second packet rate.
6. The method of item 4, further comprising:
   on condition that the received packet rate information comprise information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node,
      performing (S4) min processing on each of the blocks of packets to obtain a min delay value for each block, the min delay value being the smallest delay for a packet in said block;
      estimating (S5) the variance of the min delay values between two or more blocks, such as adjacent/neighboring blocks, or the variance of the min values within a same block;
      comparing (S6) the estimated variance with a preset nominal variance value to obtain a steering parameter;
      on condition that the obtained steering parameter is positive:
         increasing (S7A) the packet rate such that the steering parameter becomes zero to obtain a second packet rate;
      on condition that the obtained steering parameter is negative:
         decreasing (S7B) the packet rate such that the steering parameter becomes zero to obtain a second packet rate;
      on a condition that the obtained steering parameter is zero,
         maintaining (S7C) the first packet rate to obtain a second rate; and packet
      selecting (S8) a second packet rate for transmission based on the received packet rate information as the obtained second packet rate.
7. The method of item 4, further comprising:
   on condition that the received packet rate information comprise information relating to how the second node has split the plurality of packets into a sequence of blocks of packets and a min delay value for each block, the min delay value being the smallest delay for a packet in said block,
      estimating (S5) the variance of the min delay values between two or more blocks, such as adjacent/neighboring blocks, or the variance of the min values within a same block;
      comparing (S6) the estimated variance with a preset nominal variance value to obtain a steering parameter;
      on condition that the obtained steering parameter is positive:
         increasing (S7A) the packet rate such that the steering parameter becomes zero to obtain a second packet rate;
      on condition that the obtained steering parameter is negative:
         decreasing (S7B) the packet rate such that the steering parameter becomes zero to obtain a second packet rate;
      on a condition that the obtained steering parameter is zero,
         maintaining (S7C) the first packet rate to obtain a second packet rate; and
      selecting (S8) a second packet rate for transmission based on the received packet rate information as the obtained second packet rate.
8. The method of item 4, further comprising:
   on condition that the received packet rate information comprise information relating to how the second node has split the plurality of packets into a sequence of blocks of packets and an estimated variance of min delay values, the min delay values being the smallest delay for a packet in each block,
      comparing (S6) the estimated variance with a preset nominal variance value to obtain a steering parameter;
      on condition that the obtained steering parameter is positive:
         increasing (S7A) the packet rate such that the steering parameter becomes zero to obtain a second packet rate;
      on condition that the obtained steering parameter is negative:
         decreasing (S7B) the packet rate such that the steering parameter becomes zero to obtain a second packet rate;
      on a condition that the obtained steering parameter is zero,
         maintaining (S7C) the first packet rate to obtain a second packet rate; and
      selecting (S8) a second packet rate for transmission based on the received packet rate information as the obtained second packet rate.
9. The method of item 4, further comprising:
   on condition that the received packet rate information comprise a steering parameter, the steering parameter relating to a difference between a variance of min delay values, the min delay values being the smallest delay for a packet in each block of a sequence of blocks as formed in the second node upon receiving the plurality of packets, and a preset nominal variance value, and
      on condition that the obtained steering parameter is positive:
         increasing (S7A) the packet rate such that the steering parameter becomes zero to obtain a second packet rate;
      on condition that the obtained steering parameter is negative:
         decreasing (S7B) the packet rate such that the steering parameter becomes zero to obtain a second packet rate;
      on a condition that the obtained steering parameter is zero,
         maintaining (S7C) the first packet rate to obtain a second packet rate; and
      selecting (S8) a second packet rate for transmission based on the received packet rate information as the obtained second packet rate.
10. The method of item 4, further comprising:
   on condition that the received packet rate information comprise an obtained second packet rate, the obtained second packet rate being based on a steering parameter such that if steering parameter is positive, the packet rate is increased until the steering parameter becomes zero to obtain a second packet rate and if the steering parameter is negative, the packet rate is decreased until the steering parameter becomes zero to obtain a second packet rate, and if the steering parameter is zero, the first packet rate is used to obtain a second packet rate, the steering parameter relating to a difference between a variance of min delay values, the min delay values being the smallest delay for a packet in each block of a sequence of blocks as formed in the second node upon receiving the plurality of packets, and a preset nominal variance value,
      selecting (S8) a second packet rate for transmission based on the received packet rate information as the obtained second packet rate.
11. The method according to item 4, wherein the preset nominal variance value is set based on the target application.
12. The method according to any one of items 4-11, wherein the second packet rate for transmission has a preset maximum value of a maximum second packet rate a preset minimum value of a minimal second packet rate, the method further comprising:
   on condition that the obtained second packet rate exceeds the maximum value:
      selecting (S8A) the second packet rate for transmission based on the received packet rate information as the maximum second packet rate;
   on condition that the obtained second packet rate subceeds the minimum value:
      selecting (S8B) the second packet rate for transmission based on the received packet rate information as the minimum second packet rate.
13. The method according to item 4, further comprising:
   if the selected second packet rate for transmission is equal to the preset maximum second packet rate,
   setting off (S9) an alarm that the maximum second packet rate has been reached.
14. A method for use in a second node for enabling enhanced timing recovery between a first node and the second node in a network, the method comprising:
   receiving (S11), from a first node, a plurality of packets transmitted using a first packet rate for transmission, each packet comprising a timestamp t1, the timestamp t1 relating to a time when the packet was transmitted in relation to a local clock in the first node,
   timestamping (S12) each of the received plurality of packets with a timestamp t2, the timestamp t2 relating to a time when a respective packet was received in relation to a local clock in the second node,
   splitting (S13) the plurality of packets into a sequence of blocks of packets;
   transmitting (S19) a feedback parameter comprising packet rate information to the first node.
15. The method according to item 14, wherein the method further comprises:
   determining (S14) time differences between the timestamps t2 and t1 for each packet in each block of packets to obtain a delay for each packet;
   performing (S15) min processing on each of the blocks of packets to obtain a min delay value for each block, the min delay value being the smallest delay for a packet in said block;
   estimating (S16) the variance of the min delay values between two or neighboring more blocks;
   comparing (S17) the estimated variance with a preset nominal variance value to obtain a steering parameter;
on condition that the obtained steering parameter is positive:
   increasing (S18A) the packet rate such that the steering parameter becomes zero to obtain a second packet rate;
on condition that the obtained steering parameter is negative:
   decreasing (S18B) the packet rate such that the steering parameter becomes zero to obtain a second packet rate;
on a condition that the obtained steering parameter is zero,
   maintaining (S18C) the first packet rate to obtain a second packet rate; and
   transmitting (S19) a feedback parameter comprising packet rate information comprising the obtained second packet rate,
   wherein the steps S14-S18 may be performed by any of the first node and the second node.
16. The method according to items 14 or 15, the method comprising:
   on condition that the packet rate information comprises information relating to a sequence of blocks of packets and, for each of the plurality of packets, a timestamp t2,
      transmitting (S19A) a feedback parameter comprising packet rate information comprising information relating to how the second node has split the plurality of packets into a sequence of blocks of packets and, for each of the plurality of packets, a timestamp t2, the timestamp t2 relating to a time when a respective packet was received in relation to a local clock in the second node.
17. The method according to items 14 or 15, the method comprising:
   on condition that the packet rate information comprises information relating to how the second node has split the plurality of packets into a sequence of blocks of packets and a delay for each packet of the plurality of packets,
      determining (S14) time differences between the timestamps t2 and t1 for each packet in each block of packets to obtain a delay for each packet; and
      transmitting (S19B) a feedback parameter comprising packet rate information comprising information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node.
18. The method according to items 14 or 15, the method comprising:
   on condition that the packet rate information comprises information relating to how the second node has split the plurality of packets into a sequence of blocks of packets and a min delay value for each block,
      determining (S14) time differences between the timestamps t2 and t1 for each packet in each block of packets to obtain a delay for each packet;
      performing (S15) min processing on each of the blocks of packets to obtain a min delay value for each block, the min delay value being the smallest delay for a packet in said block; and
      transmitting (S19C) a feedback parameter comprising packet rate information comprising information relating to how the second node has split the plurality of packets into a sequence of blocks of packets and a min delay value for each block.
19. The method according to items 14 or 15, the method comprising:
   on condition that the packet rate information comprises information relating to how the second node has split the plurality of packets into a sequence of blocks of packets and an estimated variance of min delay values,
      determining (S14) time differences between the timestamps t2 and t1 for each packet in each block of packets to obtain a delay for each packet;
      performing (S15) min processing on each of the blocks of packets to obtain a min delay value for each block, the min delay value being the smallest delay for a packet in said block;
      estimating (S16) the variance of the min delay values between two or more blocks, such as adjacent/neighboring blocks, or the variance of the min values within a same block; and
      transmitting (S19D) a feedback parameter comprising packet rate information comprising information relating to how the second node has split the plurality of packets into a sequence of blocks of packets and an estimated variance of min delay values.
20. The method according to items 14 or 15, the method comprising:
   on condition that the packet rate information comprises information relating to a steering parameter,
      determining (S14) time differences between the timestamps t2 and t1 for each packet in each block of packets to obtain a delay for each packet;
      performing (S15) min processing on each of the blocks of packets to obtain a min delay value for each block, the min delay value being the smallest delay for a packet in said block;
      estimating (S16) the variance of the min delay values between two or more blocks, such as adjacent/neighboring blocks, or the variance of the min values within a same block;
      comparing (S17) the estimated variance with a preset nominal variance value to obtain a steering parameter; and
      transmitting (S19E) a feedback parameter comprising packet rate information comprising the steering parameter.
21. The method according to items 14 or 15, the method comprising:
   on condition that the packet rate information comprises an obtained second packet rate,
      determining (S14) time differences between the timestamps t2 and t1 for each packet in each block of packets to obtain a delay for each packet;
      performing (S15) min processing on each of the blocks of packets to obtain a min delay value for each block, the min delay value being the smallest delay for a packet in said block;
      estimating (S16) the variance of the min delay values between two or more blocks, such as adjacent/neighboring blocks, or the variance of the min values within a same block;
      comparing (S17) the estimated variance with a preset nominal variance value to obtain a steering parameter;
   on condition that the obtained steering parameter is positive:
      increasing (S18A) the packet rate such that the steering parameter becomes zero to obtain a second packet rate;
   on condition that the obtained steering parameter is negative:
      decreasing (S18B) the packet rate such that the steering parameter becomes zero to obtain a second packet rate;
   on a condition that the obtained steering parameter is zero,
      maintaining (S18C) the first packet rate to obtain a second packet rate; and
      transmitting (S19F) a feedback parameter comprising packet rate information comprising the obtained second packet rate.
22. The method according to items 15-21, wherein the second packet rate for transmission has a preset maximum value of a maximum second packet rate a preset minimum value of a minimal second packet rate, the method further comprising:
   on condition that the obtained second packet rate exceeds the maximum value,
      selecting (S191) the second packet rate for transmission based on the received packet rate information as the maximum second packet rate; on condition that the obtained second packet rate subceeds the minimum value,
      selecting (S192) the second packet rate for transmission based on the received packet rate information as the minimum second packet rate.
23. The method according to items 15-22, wherein the second packet rate for transmission has a preset maximum value of a maximum second packet rate a preset minimum value of a minimal second packet rate, the method further comprising:
   on condition that the obtained second packet rate exceeds or is equal to the maximum value,
      setting of (S20A) an alarm that the maximum packet rate has been reached.
24. The method according to any one of items 1-23, wherein altered packet rate correlates with an altered block size.
25. A first node (20), comprising processing circuitry (22) configured to enable timing recovery between the first node and a second node in a network (100), the node (20) comprising:
   a communication interface (21);
   an internal clock (25);
   processing circuitry (22) including a memory (23) and processor (24) configured to cause the node (20) to carry out the method according to any one of items 2-13 and 24.
26. A second node (10), comprising processing circuitry (12) configured to enable timing recovery between a first node and the second node in a network (100), the node (10) comprising:
   a communication interface (11);
   an internal clock (15);
   processing circuitry (12) including a memory (13) and processor (14) configured to cause the node (10) to carry out the method according to any one of items 14-24.
27. A node according to items 25 or 26, wherein the node is any node in a network that employs time transfer methods, such as a mux, router or switch or a compute node such as a server or host computer performing synchronization functions, including acting slave to a sync master, boundary clock, transparent clock or a grandmaster.
28. A method for enabling enhanced timing recovery between a first and a second node, the method comprising:
   transmitting (S100), from a first node to the second node, a plurality of packets to a second node using a first packet rate for transmission, each packet comprising a timestamp t1, the timestamp t1 relating to a time when the packet was transmitted in relation to a local clock in the first node;
   timestamping (S101), in the second node, each of the received plurality of packets with a timestamp t2, the timestamp t2 relating to a time when a respective packet was received in relation to a local clock in the second node;
   splitting (S102) the plurality of packets into a sequence of blocks of packets;
   optionally transmitting (S103), from the second node to the first node, a feedback parameter comprising packet rate information relating to how the second node has split the plurality of packets into a sequence of blocks of packets and, for each of the plurality of packets, a timestamp t2, the timestamp t2 relating to a time when a respective packet was received in relation to a local clock in the second node;
   determining (S104), in the first or second node, time differences between the timestamps t2 and t1 for each packet in each block of packets to obtain a delay for each packet;
   on condition that the determining of the time differences has been carried out in the second node,
   optionally transmitting (S105), from the second node to the first node a feedback parameter comprising packet rate information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node;
   performing (S106), in the first or second node, min processing on each of the blocks of packets to obtain a min delay value for each block, the min delay value being the smallest delay for a packet in said block;
   on condition that the min processing has been performed in the second node,
   optionally transmitting (S107) a feedback parameter comprising packet rate information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet;
      estimating (S108), in the first or second node, the variance of the min delay values between two or more neighboring blocks;
   on condition that the estimation has been performed in the second node,
   optionally transmitting (S109) a feedback parameter comprising packet rate information relating to how the second node has split the plurality of packets into a sequence of blocks of packets and an estimated variance of min delay values, the min delay values being the smallest delay for a packet in each block;
      comparing (S110), in the first or second node, comparing (S6) the estimated variance with a preset nominal variance value to obtain a steering parameter;
   on condition that the comparison has been performed in the second node,
   optionally transmitting (S111), from the second node to the first node, a feedback parameter comprising packet rate information comprising the steering parameter;
   on condition that the obtained steering parameter is positive:
      increasing (S112A) the packet rate such that the steering parameter becomes zero to obtain a second packet rate in the first or second node;
   on condition that the obtained steering parameter is negative:
      decreasing (S112B) the packet rate such that the steering parameter becomes zero to obtain a second packet rate in the first or second node;
   on a condition that the obtained steering parameter is zero,
      maintaining (S112C) the first packet rate to obtain a second packet rate in the first or second node;
   on condition that the second packet rate was obtained at the second node,
      transmitting (113) from the second node to the first node, the feedback parameter comprising packet rate information being the obtained second packet rate; and
      selecting (S114A), in the first node, a second packet rate for transmission based on the received feedback parameter;
   on condition that the second packet rate was obtained at the first node,
      selecting (S114B), in the first node, a second packet rate for transmission as the obtained second packet rate; and
   optionally transmitting (S115) a second plurality of packets from the first node to the second node using the second packet rate for transmission.

1. A method for enabling enhanced timing recovery between a first node and a second node in a network, the method comprising:
transmitting, from a first node to a second node, a plurality of packets using a first packet rate for transmission;
monitoring, by the second node, one or more properties of the transmission of the plurality of packets to obtain a feedback parameter;
transmitting from the second node to the first node, the feedback parameter based the on the one or more of the monitored properties; and
selecting, in the first node, a second packet rate for transmission based on the received feedback parameter, wherein the feedback parameter transmitted to the first node i) allows the first node to select the second packet rate for transmission based on said parameter, or ii) is the second packet rate for transmission as determined by the second node based on the one or more properties of the transmission.

2. The method according to claim 1, wherein the one or more properties being monitored is selected from: min delay value variance between different blocks of packets, wherein the min delay value for a block is a delay of a minimum delay packet of the block obtained by min processing, delay variance for all packets, dynamic change in value of a calculated internal node clock, packet loss, dynamic change in round trip time of min packets, and quality parameters on all data packets on a link.

3. A method for use in a first node, for enabling enhanced timing recovery between the first node and a second node in a network, the method comprising:
transmitting a plurality of packets to a second node using a first packet rate for transmission, each packet comprising a timestamp t1, the timestamp t1 relating to a time when the packet was transmitted in relation to a local clock in the first node;
receiving a feedback parameter comprising packet rate information from the second node; and
selecting a second packet rate for transmission based on the received packet rate information, wherein the received packet rate information is based on one or more properties of the transmission of the plurality of packets derived from the timestamps for the plurality of packets, the one or more properties being selected from: min delay value variance between different blocks of packets, delay variance for all packets, dynamic change in value of a calculated internal node clock, packet loss, dynamic change in round trip time of min packets, and quality parameters on all data packets on a link.

4. The method according to claim 3, wherein the second node has split the plurality of packets into a sequence of blocks of packets and, for each of the plurality of packets, timestamped it with a timestamp t2, the timestamp t2 relating to a time when a respective packet was received in relation to a local clock in the second node, the method further comprises:
determining time differences between the timestamps t2 and t1 for each packet in each block of packets to obtain a delay for each packet;
performing min processing on each of the blocks of packets to obtain a min delay value for each block, the min delay value being the smallest delay for a packet in said block, wherein min processing selects a packet from each block having a lowest delay as a min sample of said block;
estimating the variance of the min delay values between two or more blocks, such as adjacent/neighboring blocks;
comparing the estimated variance with a preset nominal variance value to obtain a steering parameter;
on condition that the obtained steering parameter is positive:
increasing the packet rate such that the steering parameter becomes zero to obtain a second packet rate;
on condition that the obtained steering parameter is negative:
decreasing the packet rate such that the steering parameter becomes zero to obtain a second packet rate;
on a condition that the obtained steering parameter is zero,
maintaining the first packet rate to obtain a second packet rate; and
selecting the second packet rate for transmission based on the received packet rate information as the obtained second packet rate;
wherein the steps S3-S7 may be performed by any of the first node and the second node.

5. The method according to claim 4, wherein the preset nominal variance value is set based on the target application.

6. The method according to any one of claim 1, wherein the second packet rate for transmission has a preset maximum value of a maximum second packet rate a preset minimum value of a minimal second packet rate, the method further comprising:
on condition that the obtained second packet rate exceeds the maximum value:
selecting the second packet rate for transmission based on the received packet rate information as the maximum second packet rate;
on condition that the obtained second packet rate subceeds the minimum value:
selecting the second packet rate for transmission based on the received packet rate information as the minimalum second packet rate.

7. The method according to claim 6, further comprising:
on condition that the selected second packet rate for transmission is equal to the preset maximum second packet rate,
setting off an alarm that the maximum second packet rate has been reached.

8. A method for use in a second node for enabling enhanced timing recovery between a first node and the second node in a network, the method comprising:
receiving, from a first node, a plurality of packets transmitted using a first packet rate for transmission, each packet comprising a timestamp t1, the timestamp t1 relating to a time when the packet was transmitted in relation to a local clock in the first node,
timestamping each of the received plurality of packets with a timestamp t2, the timestamp t2 relating to a time when a respective packet was received in relation to a local clock in the second node,
splitting the plurality of packets into a sequence of blocks of packets;
transmitting a feedback parameter comprising packet rate information to the first node, wherein the feedback parameter is derived from the timestamps for the plurality of packets.

9. The method according to claim 8, wherein the method further comprises:
determining time differences between the timestamps t2 and t1 for each packet in each block of packets to obtain a delay for each packet;
performing min processing on each of the blocks of packets to obtain a min delay value for each block, the min delay value being the smallest delay for a packet in said block, wherein min processing selects a packet from each block having a lowest delay as a min sample of said block;
estimating the variance of the min delay values between two or neighboring more blocks;
comparing the estimated variance with a preset nominal variance value to obtain a steering parameter;
on condition that the obtained steering parameter is positive:
increasing the packet rate such that the steering parameter becomes zero to obtain a second packet rate;
on condition that the obtained steering parameter is negative:
decreasing the packet rate such that the steering parameter becomes zero to obtain a second packet rate;
on a condition that the obtained steering parameter is zero,
maintaining the first packet rate to obtain a second packet rate; and
transmitting packet rate information comprising the obtained second packet rate,
wherein the steps S14-S18 may be performed by any of the first node and the second node.

10. The method according to claim 9, wherein the second packet rate for transmission has a preset maximum value of a maximum second packet rate a preset minimum value of a minimal second packet rate, the method further comprising:
on condition that the obtained second packet rate exceeds the maximum value,
selecting the second packet rate for transmission based on the received packet rate information as the maximum second packet rate;
on condition that the obtained second packet rate subceeds the minimum value,
selecting the second packet rate for transmission based on the received packet rate information as the minimalmum second packet rate.

11. The method according to claim 8, wherein the second packet rate for transmission has a preset maximum value of a maximum second packet rate a preset minimum value of a minimal second packet rate, the method further comprising:
on condition that the obtained second packet rate exceeds or is equal to the maximum value,
setting of an alarm that the maximum packet rate has been reached.

12. The method according to claim 1 wherein a second packet rate being different from a first packet rate constitutes an altered packet rate, which altered packet rate correlates with an altered block size.

13. A first node, comprising processing circuitry configured to enable timing recovery between the first node and a second node in a network, the node; comprising:
a communication interface;
an internal clock;
processing circuitry including a memory and processor configured to cause the node to carry out the method according to claim 3.

14. A second node, comprising processing circuitry configured to enable timing recovery between a first node and the second node in a network, the node comprising:
a communication interface;
an internal clock;
processing circuitry including a memory and processor configured to cause the node to carry out the method according to claim 8.

15. The method according to claim 1, the method comprising:
transmitting, from a first node to the second node, a the plurality of packets to a second node using the a first packet rate for transmission, each packet comprising a timestamp t1, the timestamp t1 relating to a time when the packet was transmitted in relation to a local clock in the first node;
timestamping, in the second node, each of the received plurality of packets with a timestamp t2, the timestamp t2 relating to a time when a respective packet was received in relation to a local clock in the second node;
splitting the plurality of packets into a sequence of blocks of packets;
optionally transmitting, from the second node to the first node, a feedback parameter comprising packet rate information relating to how the second node has split the plurality of packets into a sequence of blocks of packets and, for each of the plurality of packets, a timestamp t2, the timestamp t2 relating to a time when a respective packet was received in relation to a local clock in the second node;
determining, in the first or second node, time differences between the timestamps t2 and t1 for each packet in each block of packets to obtain a delay for each packet;
on condition that the determining of the time differences has been carried out in the second node,
optionally transmitting, from the second node to the first node a feedback parameter comprising packet rate information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node;
performing, in the first or second node, min processing on each of the blocks of packets to obtain a min delay value for each block, the min delay value being the smallest delay for a packet in said block;
on condition that the min processing has been performed in the second node,
optionally transmitting a feedback parameter comprising packet rate information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet;
estimating, in the first or second node, the variance of the min delay values between two or more neighboring blocks;
on condition that the estimation has been performed in the second node,
optionally transmitting a feedback parameter comprising packet rate information relating to relating to how the second node has split the plurality of packets into a sequence of blocks of packets and an estimated variance of min delay values, the min delay values being the smallest delay for a packet in each block;
comparing, in the first or second node, comparing (S6) the estimated variance with a preset nominal variance value to obtain a steering parameter;
on condition that the comparison has been performed in the second node,
optionally transmitting, from the second node to the first node, a feedback parameter comprising packet rate information comprising the steering parameter;
on condition that the obtained steering parameter is positive:
increasing the packet rate such that the steering parameter becomes zero to obtain a second packet rate in the first or second node;
on condition that the obtained steering parameter is negative:
decreasing the packet rate such that the steering parameter becomes zero to obtain a second packet rate in the first or second node;
on a condition that the obtained steering parameter is zero,
maintaining the first packet rate to obtain a second packet rate in the first or second node;
on condition that the second packet rate was obtained at the second node,
transmitting from the second node to the first node, the feedback parameter comprising packet rate information being the obtained second packet rate; and
selecting, in the first node, a second packet rate for transmission based on the received feedback parameter,
on condition that the second packet rate was obtained at the first node,
selecting, in the first node, a second packet rate for transmission as the obtained second packet rate.
